(19) United States
(12) Patent Application Publication
(10) Pub. No.: US 2015/0193551 A1
(43) Pub. Date: Jul. 9, 2015

(54) SYSTEM AND METHOD FOR FACILITATING RESEARCH COLLABORATION CROSS REFERENCE

(71) Applicants: Joshua Asher Gordon, Philadelphia, PA (US); Leonard Gordon, Mill Valley, CA (US)

(72) Inventors: Joshua Asher Gordon, Philadelphia, PA (US); Leonard Gordon, Mill Valley, CA (US)

(21) Appl. No.: 14/592,588

(22) Filed: Jan. 8, 2015

Related U.S. Application Data
(60) Provisional application No. 61/925,082, filed on Jan. 8, 2014.

(51) Int. Cl. G06F 17/30; G06F 3/0482; G06F 3/0484

(52) U.S. Cl. CPC G06F 17/30876; G06F 3/04842; G06F 3/0482

(57) ABSTRACT

A system and method for facilitating research collaboration is disclosed. The invention provides an interface configured for enabling the potential research collaborations from the web based resource on the basis of social network aspect and data parameters etc. The present invention further provides a facility of creating a structured database for the collaborated research study with automated outputs for collaborating members. The present invention also enables the user to evaluate, monitor the data and to generate a research study output at any point of time.

### CROSS REFERENCE

The present invention is taking reference of provisional patent application No. 61/925,082 dated Jan. 8, 2014, and entitled “A method/process of using an online social network designed for the formation of research collaborations that create customizable databases with automated outputs for collaborating parties.”

### FIELD OF INVENTION

The present invention relates to a system and a method for facilitating research collaboration using web based resources. More specifically, the present invention relates to a method for facilitating research collaborations and providing a database for storing the data for collaborated research.

### BACKGROUND OF INVENTION

A research study is basically a result of collaboration of data gathered from variety of publicly available resources, improvements in open research and scientific reviews. To accomplish a research study, many times a researcher may require association with other researchers working in similar fields or on similar topics. There are various web based research resources or databases such as Research Gate™, IEEE e-Journals™, google Scholar™ etc. that allow discussion and sharing of journal articles and data between researchers.

A few web-based social networks for specialized professional groups such as WebMed™ provide the facility of exchanging information by creating groups. However, such existing systems do not provide any facility to establish a potential collaboration and to take the next step in allowing the researcher to design the research experiment.

Sometimes, a researcher may succeed in creating collaborations with other researchers, but it can be difficult for them to store the data in an organized manner and further to set up a database and process their data. Although web base research resources provide information and previous published data sets, non allow for active collaborative data collection. Though, many web based resources provide a variety of research study and projects, yet, it is often difficult to find the appropriate data and to interpret them from the perspective of the study.

There are some applications such as REDCap™ that are designed to support data capture for research studies. However, they are incapable of processing the data automatically in a study specific fashion. In such applications, a user input is required for statistical evaluation and other data processing. The techniques available do not allow for collaborations to form amongst members of a larger body of potential collaborators, rather they only allow for existing collaborations to collect data and then at some later date process the collected data. Further such resources do not provide specific tools to facilitate these collaborative research efforts, creating substantial inefficiencies in collaborative efforts. As a result existing systems are inefficient for making comparison between data sets, monitoring data or handling data after collection in collaborative efforts. From the formation of the collaboration through the conducting of research current methods leave substantial room for improvement.

Hence, in light of the above discussion, there is need for devising a system and method for facilitating research collaboration by enabling the potential collaborations. It is also desirable to develop a method for providing a structured database for storage of collaborative research and for facilitating evaluation and monitoring of research data.

### SUMMARY OF INVENTION

The invention under study is directed towards a system and a method for effectively facilitating research collaborations. The present invention discloses a method for facilitating research collaboration, the method being implementable on a computing device, the method including the steps of providing an interface to a user, the interface enabling selection from a list of potential collaborators and forming a research collaboration; providing a database for storage of data by the user and one or more members of said research collaboration, and enabling processing of said data to produce a research study output.

It is a further object of the present invention to provide an interface enabling the selection of a list of potential collaborators sourced from at least one web based resource selected from the group comprising a social networking website, a research website, a university website, a research institute website, and a consultancy website.

It is another object of the present invention to provide a research collaboration system, comprising: an interface to enable a user to select from a list of potential collaborators; and form a research collaboration; a database for storage of data by the user and one or more members of said research collaboration; and a processor configured to execute instructions stored in a non-transitory storage medium, the processor configured to process the data and facilitating a research study output.

It is a further object of the present invention to provide a computer program product arranged for facilitating collaborated research, the computer program product comprising at least one non-transitory computer-readable storage medium having computer-readable program code portions stored therein, said computer-readable program code portions comprising instructions for: providing an interface to a user, the interface enabling: selecting from a list of potential collaborators; and forming a research collaboration; providing a database for storage of data by the user and one or more members of the research collaboration; enabling processing of the data to produce a research study output.

Some or all of the aforementioned advantages of the invention are accrued by configuring an interface for enabling the user to store the data according to the one or more parameters such as data scores, satisfaction ratings, angles, growth, loss, ordinal data, continuous data and type of data. Further advantages and features of the present invention are considered by configuring the interface for selecting and/or providing processing of the data, examining, evaluating and monitoring of the data.

This invention is pointed out with particularity to the appended claims. Additional features and advantages of the system will become apparent to those skilled in the art by referring to the following detailed description taken in conjunction with the accompanying drawings.

### BRIEF DESCRIPTION OF DRAWINGS

The features of the present invention, which are believed to be novel, are set forth with particularity in the appended claims. The invention may best be understood by reference to the following description, taken in conjunction with the accompanying figures. These figures and the associated description are provided to illustrate some embodiments of the invention, and not to limit the scope of the invention.

In the following the invention will be described in greater detail with reference to exemplary embodiments in accordance with the accompanying drawings, in which:

FIG. 1 illustrates a flow chart representing a method for facilitating research collaboration, in accordance with an embodiment of the present invention;

FIG. 2 illustrates an interface that provides a data collection page to a user and/or to collaborators for collection of data, in accordance with another embodiment of the present invention;

FIG. 3 illustrates an interface that provides a selection page for automated pre and post processing of data collected by the collaborators, in accordance with another embodiment of the present invention;

FIG. 4 illustrates an interface that provides a research study page showing collaborating members, in accordance with another embodiment of the present invention; and

FIG. 5 illustrates a research collaboration system, in accordance with another embodiment of the present invention.

The features of the invention illustrated above and below in the specification, are described with reference to the drawings summarized above. The reference numbers shown in the drawings may be used at one or more places to indicate the functional relation between the referenced elements. Some of the embodiments are described in the dependent claims.

### DETAILED DESCRIPTION OF THE INVENTION

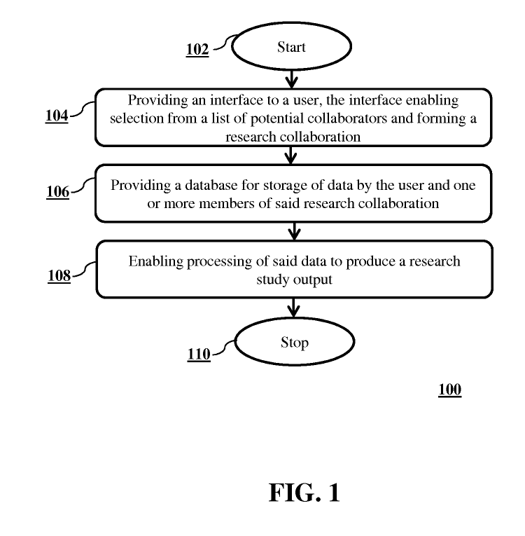

The following detailed description is merely exemplary in nature and is to enable any person skilled in the art to make and use the invention. The examples shown in description are not intended to limit the application and uses of the various embodiments. Various modifications to the disclosed invention will be readily apparent to those skilled in the art, and the methodology defined herein may be applied to other embodiments and applications without departing from the spirit and scope of the present disclosure. Thus, the present invention is not limited to the examples shown, but is to be accorded the widest scope consistent with the methodology and features disclosed herein. It should also be noted that FIGS. 1-5 are merely illustrative and may not be drawn to scale.

Embodiments of the present invention provide a system and a method for effectively facilitating research collaborations. Referring to FIG. 1, an embodiment of the present invention provides a method 100 for facilitating research collaboration. The method 100 can be implemented in the form of a computer program product executable on any computing device such as a computer system, mobile and others dedicated systems.

The method 100 is initiated at step 102.

At step 104, an interface is provided to a user. The interface enables the selection from a list of potential collaborators. The list of potential collaborators may be sourced from any web based resource. The web based resource may be selected from the group including a social networking website, a research website, a university website, a research institute website, and a consultancy website. A potential collaborator may be a person having an interest or having done research work similar to the user.

In some embodiments, the potential collaborators may be people known to the user within a specific field. The present invention provides the collaborators a platform to initiate and/or continue their research study online. The user and/or the collaborators and/or one or more members of the research collaborations may search other collaborators of similar interests and may review their work and research background. The user may then invite a potential collaborator from the list of potential collaborators to a collaboration page and may form a research group. The research group can then share contact information or via secure messaging.

Further, at step 106, a database for storage of data by the user and one or more members of the research collaboration is provided. The database can be set up using the interface before starting collection of the data.

The user and other members can log into the database at any point of time while inputting the data. The user and other members may decide to not disclose or blind the results until a certain number is reached, or decide to view ongoing output in a graphical display, statistical evaluation or recommendations on other data processing based on statistical spread etc.

In an embodiment of the present invention, the user may analyze the adequateness of the research study by allowing the system to provide suggestions or the user may analyze the completeness of study by looking at whether the entered data appears to demonstrate a normal distribution or not. The user may also examine the data using one or more of steps such as by comparing the data with the other data sets available on the web based resource; by comparing the data with the predefined historical norms; by evaluating the data as a function of time, and by evaluating the relationship of data with other parameters such as accuracy, consistency, completeness, reviews and internal consistency. Thus, the database may be designed to facilitate the full spectrum of research developments.

At step 108, processing of the data is enabled to produce a research study output. The processing of data can used various statistical approaches to evaluate the data. It can be done with the monitoring of data. This allows the collaborated database to facilitate and stream-line research while improving the quality of research. Various algorithms can be deployed for data processing in accordance with the user requirement. In some embodiment the user may select the data processing option. The data processing option may include the calculation of standard deviation, or performance of a t-test or ANOVA depending on the types of data evaluated.

In some embodiments of the present invention the statistical testing of the data may be done using one or more test such as One-sample T-test, D'Agostino's, K-squared test, Jarque-Bera test, Anderson-Darling test, One Sample Median, Chi Square test, Sample t-test, Fisher's exact test, Craner-von Mises criterion, Lilliefors test, Kolmogorov-Simirnov test, Shapiro-Wilk test, Peason's Chi-squared test, Shapiro-Francia testone-way ANOVA, Kruskal Wallis, Chi-Square goodness of fit, Paired t-test, Wilcoxon signed ranks test, McNemar, Wilcoxon-Mann Whitney test, one-way repeated measures ANOVA, Friedman test, repeated measures logistic regression, factorial ANOVA, ordered logistic regression, factorial logistic regression, Simple linear regression, non-parametric correlation, simple logistic regression, multiple regression, analysis of covariance, multiple logistic regression, discriminant analysis, one-way MANOVA, multivariate multiple linear regression, factor analysis, canonical correlation, various measurements of effect size, f-tests (more generally as seen through the list), z-tests, more general paired difference tests, Tukey's method, or customized data analysis.

The method 100 is terminated at step 110.

An embodiment of the present invention allows the real time data monitoring through the course of research study and allows for time to time outputs or alerts to members of the collaborative research effort as well as other improvements in research efficiency such as improvements using statistical evaluations, graphical representation of data, third party authentication of research methods and pre-collection appropriate and automated randomization. This system allows the consistent data storage during the research study with the reduced risk of data loss and also improves the ease of conducting meta-analysis and large scale data evaluations.

In other embodiments of the present invention the evaluation the data may be visualized using one or more graphical representations such as bar graphs, pie charts, line graphs, forest plots, funnel plots, receiver operator curves, normal probability plot, streamgraphs, histograms, Venn diagrams, normal probability plots, line or dot plots, matrix plots, tables, pictographs, heat maps, bubble charts, waterfall charts, gap charts, survival curves, pedigree charts, gantt charts, structure chart, strip charts, nomograms, growth charts, box plots, scatter plots, bi-plots, probability plots, or customized graphical outputs.

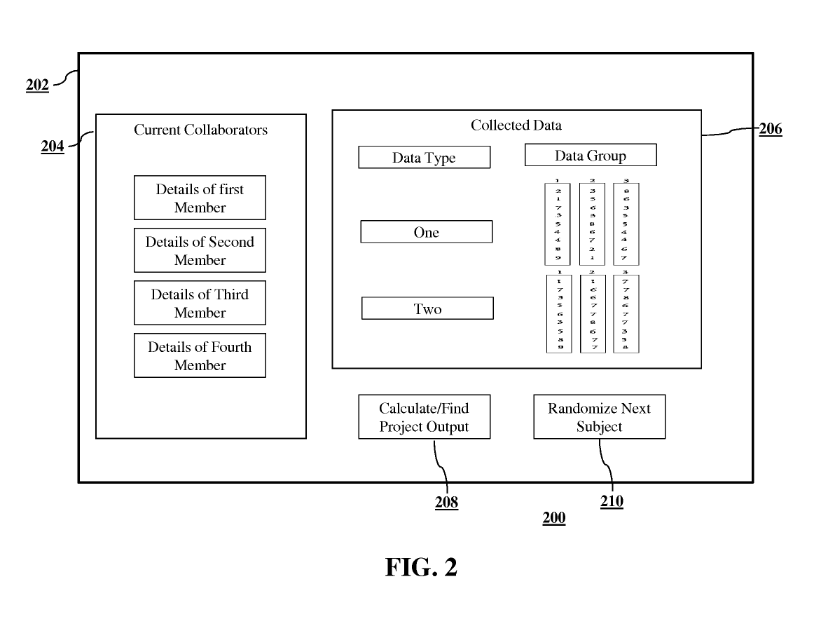

In an embodiment 200 of the present invention, FIG. 2 demonstrates an interface 202 that provides a data collection page to the user and/or to collaborators for collection of data from a web based resource. In the embodiment, a list 204 of potential collaborators is shown. The interface 202 may also provide details of the potential collaborators. The user can then select one or more members from the list 204 of the potential collaborators.

In some embodiments, the page may display the collected data 206 or data entered by the collaborators. The collected data 206 may be selected using a data type option provided on the data collection page. The data 206 further may be grouped in one or more data groups as shown in the figure.

The user can also select a Calculate/Find Project Output option available on the data collection page. Using this option the user may visualize a real-time output of the collected data 206. Further, a “randomize next subject” option is also provided to maintain confidentiality and blindness of the studies that may be otherwise disclosed or hinted to a visitor visiting the page.

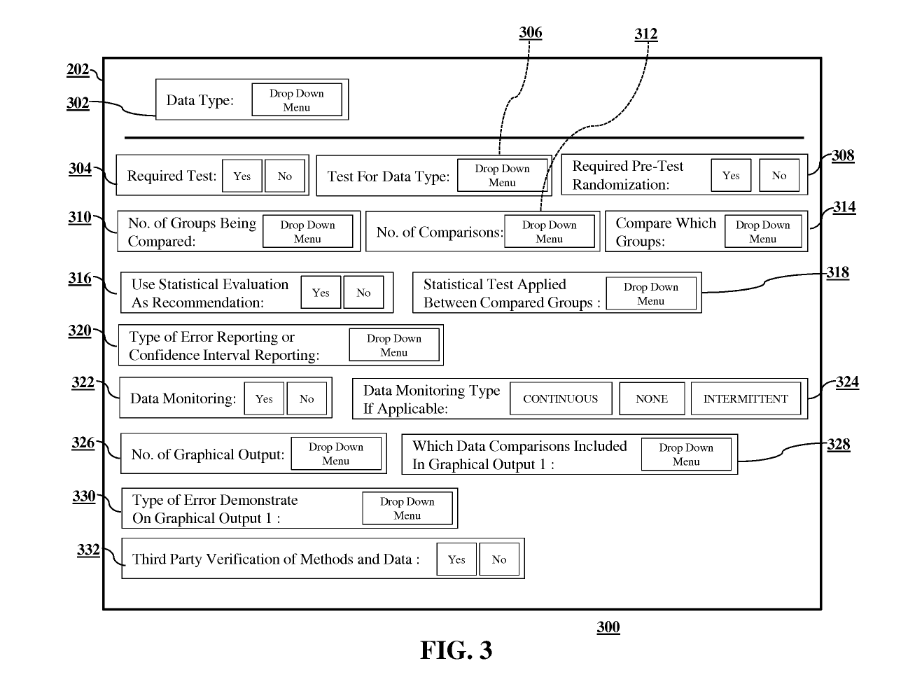

In an embodiment 300 of the present invention, FIG. 3 demonstrates the interface 202 that provides a selection page for automated pre and post processing of data from the collaborators. For processing of the data, the interface 202 may enable the user to select the data type 302 from a drop down menu. The data may be stored in the database according to data number and type that may be selected on the basis of various parameters such as data scores, satisfaction ratings, angles, growth, loss, ordinal data, continuous data and other types of data.

Further, the interface 202 enables the user to select whether he wants to test the data or not with a “Required Test” option 304. Further, the user may choose the type of test using “Test For Data Type” option 306. The interface 202 may also provide a “Required Pre Test Randomization Option” 308. If the user wants to randomize the data, he may select “Yes”.

The interface 202 further enables the user to form a group for the data. The user may compare a number of groups by selecting a number using “No. of Groups Being Compared option” 310, or may select number of comparisons using “Number of Comparisons” option 312 and may select the groups to compare using “Compare Which Group” option 314.

Further, the interface 202 enables the user to select an appropriate statistical evaluation for evaluating the data according to the data type. The user may opt for the statistical evaluation using Use Statistical Evaluation As Recommendation option 316. The user may also choose the Statistical Test Applied Between Compared Group using option 318. The interface 202 allows the user for reporting errors by providing a menu of error reporting types. The user may choose the required type using the option Type of Error Reporting or Confidence Interval Reporting option 320.

The interface 202 also provides the facility to monitor the data. The user may choose a “Data Monitoring” option 322 by clicking/pointing on “Yes”. The user may choose continuous monitoring of data, no monitoring of data or intermittent monitoring of data by selection “Data Monitoring Type” option 324.

The selection page further provides the “No. of Graphical Output” option 326 and “Which Data Comparison Included in Graphical Output” 328. The user may choose the desired data evaluation options by selecting these options. The user may also use “Type of Error Demonstrate on Graphical Output 1” option 330 to visualize the error in graphical visualization of data.

Further, the interface enables the user to select the “third party verification methods and data input” using the option 332. With this the user is allows potential other parties apart from collaborating parties to evaluate the initial input, time line for data entry and methods selected for data processing. Third parties may include reviewers, other collaborators, potential collaborators, publishers or others involved in the research process.

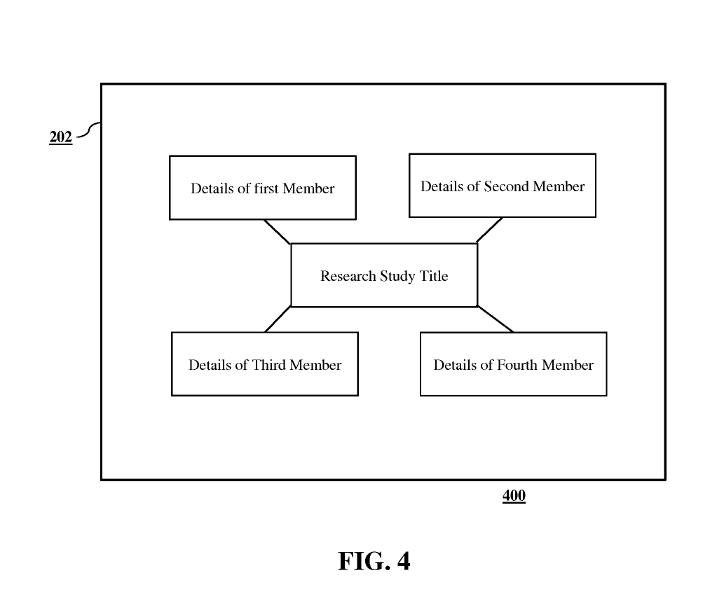

As FIG. 4 demonstrates, another embodiment of the present invention provides the interface 202 for facilitating a research study page. The research study page shows a Research Study Title of ongoing research and the details of one or more members of collaborated research study. In an embodiment the details can be viewed by clicking on the name and/or image of one or more members. The contribution of the members may also be viewed on the research study page. The user may evaluate the quality and adequateness of the contribution of each member.

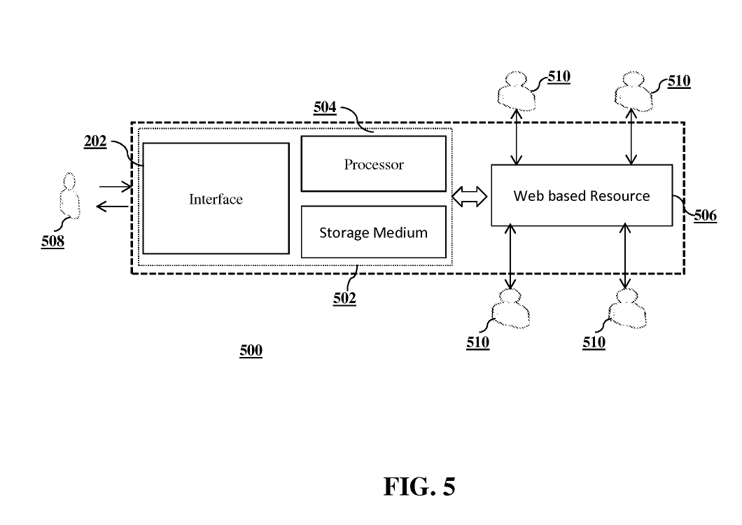

Referring to FIG. 5, another embodiment of the present invention provides a research collaboration system 500. The research collaboration system 500 includes the interface 202 to enable the user to select from a list of potential collaborators and to form research collaboration. The list of the potential collaborators is sourced from any web based resource 506. The web based resource 506 may be selected from a group including a social networking website, a research website, a university website, a research institute website, and a consultancy website.

In an embodiment of the present invention, the user may input his interest and/or field of research into the research collaboration system 500. The research collaboration system 500 can then fetch the potential collaborator. Various algorithms can be deployed for the fetching and/or selecting the potential collaborators.

In an embodiment of the present invention, the interface 202 may be in form of a display device providing the selection facility to a user 508. In other embodiments of the present invention, the interface 202 can be any hardware and/or computer program and the combination thereof which may enable the user to interact with the research collaboration system 500. The interface 202 may include display screen, keyboard, mouse, light pen, the appearance of a desktop, help messages, and how an application program or a web site invites interaction and responds to it.

In another embodiment of the present invention, the research collaboration system 500 may be any device that includes an interface to allow the user 508 to input and/or output data and may be connected to internet and/or other data sharing networks either itself or by using some dedicated device.

The research collaboration system further includes a non-transitory storage medium 502 and a processor 504. The non-transitory storage medium may be any device that can store code for use by a computer system, mobile and others. The non-transitory storage medium 502 may include, but is not limited to a volatile memory, non-volatile memory, magnetic and optical storage devices such as disk drives, magnetic tape, CDs (compact discs), DVDs (digital versatile discs or digital video discs), or other media capable of storing code now known or later developed.

In an embodiment of the present invention, the research collaboration system 500 includes a database for storage of data by the user and one or more members of the research collaboration. The research collaboration system 500 may allow the user 508 to configure the database as per his requirement. The user may create and/or customize the data gathering bin and/or the user may provide and/or distribute the storage for enabling the entering of the data by the one or more members 510 of collaborated research study.

In an embodiment of the present invention, the research collaboration system 500 enables the user 508 to provide a title for the research study and to select one or more data formats such as color, fonts and style for visualizing the evaluated data. The research collaboration system 500 may enable the user 508 to include and/or exclude the randomization of one or more members selected from the list gathered from a web based resource.

In an embodiment of the present invention, the processor 504 is configured to execute the instructions stored in the non-transitory storage medium 502. The processor is further configured to process the data using aforementioned techniques of processing of data. The processor further executes instructions for providing a research study output. The research study output may be the conclusion of collaborated research. The research study output can be generated at any point of time during and after research study.

In embodiment of the present invention, the research collaboration system 500 provides the user 508, one or more data processing techniques to finalize the data and/or to conclude the collaborated data. Thus, the research collaboration system 500 facilitates a research study output.

In an embodiment, the processing of data and the monitoring data may be done simultaneously to ensure safety of data during the research. The user 508 is enabled to share the collaborated data with a selected group and/or the one or more members 510. The research collaboration system 500 further provides an option for making research data available to the public and/or keeping the data private and/or sharing the research data with the one or more members 510.

In an embodiment of the present invention, the interface enables the user to select the one or more options from of a drop-down menu. In other embodiments, the research collaboration system 500 may provide appropriate options. The research collaboration system 500 may be configured to automatically provide data processing by providing an appropriate evaluation test, examination of data and data monitoring according to the data type and/or user inputs.

A further embodiment of the present invention provides a computer program product arranged for facilitating collaborated research. The computer program product comprising at least one non-transitory computer-readable storage medium having computer-readable program code portions stored therein, said computer-readable program code portions comprising instructions for performing aforementioned method 100. Various algorithms may be deployed for performing the method 100.

Though exemplary embodiments have been presented in the foregoing detailed description of the invention, it should be appreciated that a vast number of variations exist. It should also be note that the disclosed embodiments and methods are not intended to limit the scope and applicability of the invention in any way.

Rather, the foregoing detailed description will provide those skilled in the art with a convenient road map for implementing an exemplary embodiment of the invention, it being understood that various changes may be made in the methods and order of steps described in an exemplary embodiment without departing from the scope of the invention as set forth in the appended claims and their legal equivalents.

1. A method for facilitating research collaboration, the method being implementable on a computing device, the method comprising:
providing an interface to a user, the interface enabling:
selecting from a list of potential collaborators; and
forming a research collaboration;
providing a database for storage of data by the user and one or more members of the research collaboration; and
enabling processing of the data to produce a research study output.

2. The method as claimed in claim 1, wherein the list of potential collaborators is sourced from at least one web based resource selected from the group comprising a social networking website, a research website, a university website, a research institute website, and a consultancy website.

3. The method as claimed in claim 1 further comprising selecting the data to be stored according to one or more parameters selected from the group comprising data scores, satisfaction ratings, angles, growth, loss, ordinal data, continuous data and other type of data.

4. The method as claimed in claim 1, wherein processing of the data comprises examining the data using one or more of the following steps:
comparing the data with other data sets available on the web based resource;
comparing the data with predefined historical norms;
evaluating the data as a function of time; and
evaluating relationship of the data with other parameters such as accuracy, consistency, completeness, reviews and internal consistency.

5. The method as claimed in claim 1, wherein processing of the data comprises statistical testing of the data using one or more test selected from the group comprising One-sample T-test, D'Agostino's, K-squared test, Jarque-Bera test, Anderson-Darling test, One Sample Median, Chi Square test, Sample t-test, Fisher's exact test, Craner-von Mises criterion, Lilliefors test, Kolmogorov-Simirnov test, Shapiro-Wilk test, Peason's Chi-squared test, Shapiro-Francia testone-way ANOVA, Kruskal Wallis, Chi-Square goodness of fit, Paired t-test, Wilcoxon signed ranks test, McNemar, Wilcoxon-Mann Whitney test, one-way repeated measures ANOVA, Friedman test, repeated measures logistic regression, factorial ANOVA, ordered logistic regression, factorial logistic regression, Simple linear regression, non-parametric correlation, simple logistic regression, multiple regression, analysis of covariance, multiple logistic regression, discriminant analysis, one-way MANOVA, multivariate multiple linear regression, factor analysis, canonical correlation, various measurements of effect size, f-tests (more generally as seen through the list), z-tests, more general paired difference tests, Tukey's method, or customized data analysis.

6. The method as claimed in claim 1, wherein processing of the data comprises evaluating the data using one or more graphical representations such as bar graphs, pie charts, line graphs, forest plots, funnel plots, receiver operator curves, normal probability plot, streamgraphs, histograms, Venn diagrams, normal probability plots, line or dot plots, matrix plots, tables, pictographs, heat maps, bubble charts, waterfall charts, gap charts, survival curves, pedigree charts, gnatt charts, structure chart, strip charts, nomograms, growth charts, box plots, scatter plots, bi-plots, probability plots, or customized graphical outputs.

7. The method as claimed in claim 1 further comprising enabling of user to include and/or exclude the randomization of the one or more members selected.

8. The method as claimed in claim 1, further comprising monitoring the data entered by the user and/or the one or more members to ensure safety of data during the research study.

9. The method as claimed in claim 1 further comprising one or more of:
making the data available to public;
keeping the data private; and
sharing the data with the one or more members including third parties to verify appropriate research methods applied.

10. The method as claimed in claim 1 enabling the user and/or the one or more members to enter the data into a user-defined arrangement such as in tables, columns, or in to tailored data gathering bins.

11. A research collaboration system, comprising:
an interface to enable a user to:
select from a list of potential collaborators; and
form a research collaboration;
a database for storage of data by the user and one or more members of said research collaboration; and
a processor configured to execute instructions stored in a non-transitory storage medium, the processor configured to process the data and facilitating a research study output.

12. A computer program product arranged for facilitating collaborated research, the computer program product comprising at least one non-transitory computer-readable storage medium having computer-readable program code portions stored therein, said computer-readable program code portions comprising instructions for:
providing an interface to a user, the interface enabling:
selecting from a list of potential collaborators; and
forming a research collaboration;
providing a database for storage of data by the user and one or more members of the research collaboration;
enabling processing of the data to produce a research study output.
